(19) United States
(12) Patent Application Publication
(10) Pub. No.: US 2006/0057893 A1
(43) Pub. Date: Mar. 16, 2006

(54) Card connector prevented from short-circuiting between a ground line and a signal line

(75) Inventor: Akihiro Matsunaga, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Japan Aviation Electronics Industry, Limited, Tokyo (JP)

(21) Appl. No.: 11/220,860

(22) Filed: Sep. 7, 2005

(30) Foreign Application Priority Data
Sep. 15, 2004 (JP) 2004-268687

(51) Int. Cl. H01R 24/00

(52) U.S. Cl. 439/630

(57) ABSTRACT

In a card connector for connecting a card, a cover is engaged with an insulator holding a conductive contact and is movable with respect to the insulator for bringing the card into contact with the contact. The cover has a card receiving portion for receiving the card and first and second card holding portions extending from the card receiving portion to hold opposite side edges of the card in cooperation with the card receiving portion. The first card receiving portion has an end piece extending in an inclined position with respect to the card receiving portion. Therefore, the end piece is contacted with one edge of the card on connecting the card but is faced to and spaced from a principal surface of the card which is adjacent to the one edge.

This application claims priority to prior Japanese patent application JP 2004-268687, the disclosure of which is incorporated herein by reference.

### BACKGROUND OF THE INVENTION

This invention relates to a card connector for use in connecting a card such as an IC (Integrated Circuit) card or a SIM (Subscriber Identity Module) card.

A card connector of the type comprises an insulator holding a contact and a cover rotatable with respect to the insulator. When the cover holding a card is rotated to face the insulator, the card is contacted with the contact.

For example, Japanese Unexamined Patent Application Publication (JP-A) No. 2000-260537 discloses a card connector having a card receiving portion formed by folding back opposite side portions of a cover to hold a card. With this structure, it is possible to reduce the size of the cover and to achieve uniform contact pressure.

However, if the cover is connected to a ground line, short-circuiting between the ground line and a signal line may be caused to occur depending upon the type of the card.

Japanese Unexamined Patent Application Publication (JP-A) No. 2003-303645 discloses a card connector comprises an insulator provided with a holding portion for holding a card, and a cover provided with pressing means for pressing the card towards the holding portion. With this structure, it is possible to reduce pressing force of pressing the card.

However, the pressing means tends to be deformed during use. In this event, the pressing force of pressing the card becomes nonuniform and contact failure may sometimes occur. Thus, the card connector is insufficient in operability, durability, and reliability.

### SUMMARY OF THE INVENTION

It is therefore an object of this invention to provide a card connector which can be used for various kinds of cards without the risk of short-circuiting between a ground line and a signal line.

It is another object of this invention to provide a card connector which is capable of stably holding a card in contact therewith and which is high in operability, durability, and reliability.

Other objects of the present invention will become clear as the description proceeds.

According to an aspect of the present invention, there is provided a card connector for connecting a card. The card connector comprises an insulator, a conductive contact held by the insulator, and a cover engaged with the insulator and movable with respect to the insulator for bringing the card into contact with the contact, the cover having a card receiving portion for receiving the card and first and second card holding portions extending from the card receiving portion to hold opposite side edges of the card in cooperation with the card receiving portion, at least one of the first and the second card receiving portions having an end piece extending in an inclined position with respect to the card receiving portion so that the end piece is contacted with one edge of the card but is faced to and spaced from a principal surface of the card which is adjacent to the one edge. dr

### BRIEF DESCRIPTION OF THE DRAWING

FIG. 1A is a perspective view of a card connector according to an embodiment of this invention when a cover is opened;

FIG. 1B is a perspective view of the card connector in FIG. 1A when the cover is closed;

FIG. 2A is a perspective view similar to FIG. 1A when a card is held by the card connector;

FIG. 2B is a perspective view similar to FIG. 1B when the card is held by the card connector;

FIGS. 3A, 3B, 3C, 3D, 3E, and 3F are a plan view, a front view, a rear view, a left side view, a right side view, and a bottom view of the card connector in the state illustrated in FIG. 1B, respectively;

FIG. 4A is a perspective view of the cover of the card connector in FIGS. 1A and 1B as seen from one side of the cover;

FIG. 4B is a perspective view of the cover as seen from the opposite side;

FIGS. 5A, 5B, and 5C are a plan view, a right side view, and a front view of the cover of the card connector in FIGS. 1A and 1B, respectively;

FIG. 6A is an enlarged view of a characteristic part in FIG. 5C;

FIG. 6B is an enlarged perspective view of the characteristic part in FIG. 5C;

FIG. 7 is a perspective view of the card connector in FIGS. 1A and 1B when a different card is held; and

FIG. 8 is an enlarged perspective view of a characteristic part in FIG. 7.

### DESCRIPTION OF THE PREFERRED EMBODIMENTS

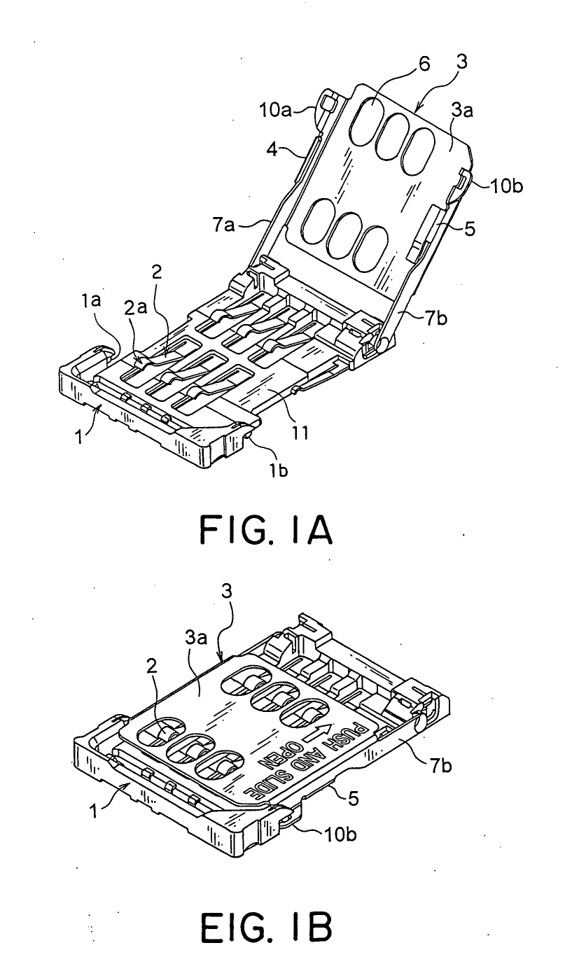

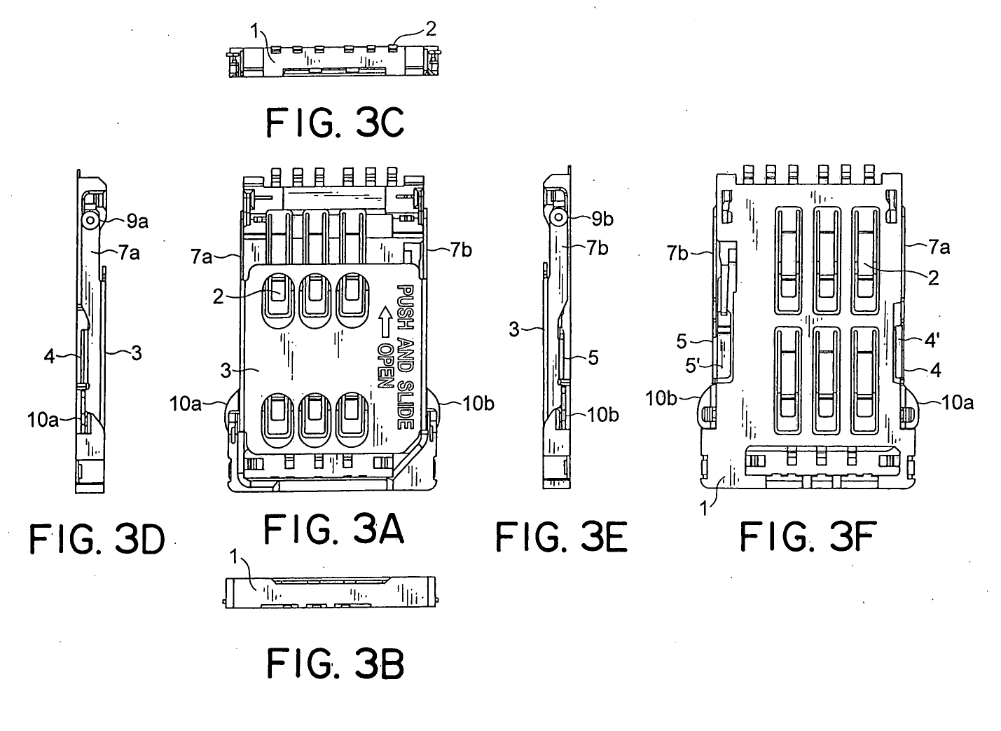

Referring to FIGS. 1A through 3F, description will be made of an overall structure of a card connector according to an embodiment of this invention.

The card connector is for connecting a card 8 such as an IC card or a SIM card and comprises an insulator 1, a plurality of (six in the illustrated example) conductive contacts 2 held by the insulator 1 to be exposed on one surface 11 of the insulator 1, and a metal cover 3 made of a metal plate. The insulator 1 has a first and a second end portion opposite to each other in a first direction A1. The cover 2 is engaged at one end thereof with the first end portion of the insulator 1 so as to be rotatable around a rotation axis extending in a second direction A2, which will be referred to as a predetermined direction. Thus, the cover 3 is movable with respect to the insulator 1 between an opened position (FIG. 1A) at which the cover 3 is spaced from the one surface 11 and a closed position (FIG. 1B) at which the cover 3 is faced to the one surface 11. At the closed position, the other end of the cover 3 is adapted to be locked to the insulator 1 by a structure which will later be described. Each contact 2 has a contacting portion 2a protruding from the one surface 11 of the insulator 1.

The cover 3 has a plate-like cover receiving portion 3a for receiving a card 8, and first and second card holding portions 4 and 5 formed on opposite sides of the card receiving portion 3a. More particularly, the first and the second card holding portions 4 and 5 are spaced from each other in the second direction A2. Each of the first and the second card holding portions 4 and 5 is formed by folding back a part of the cover 3. Thus, the cover 3 has a generally U-shaped section corresponding to each of the first and the second card holding portions 4 and 5. It is to be noted that the contacts 2 are eccentrically located near the first holding portion 4 in the second direction A2.

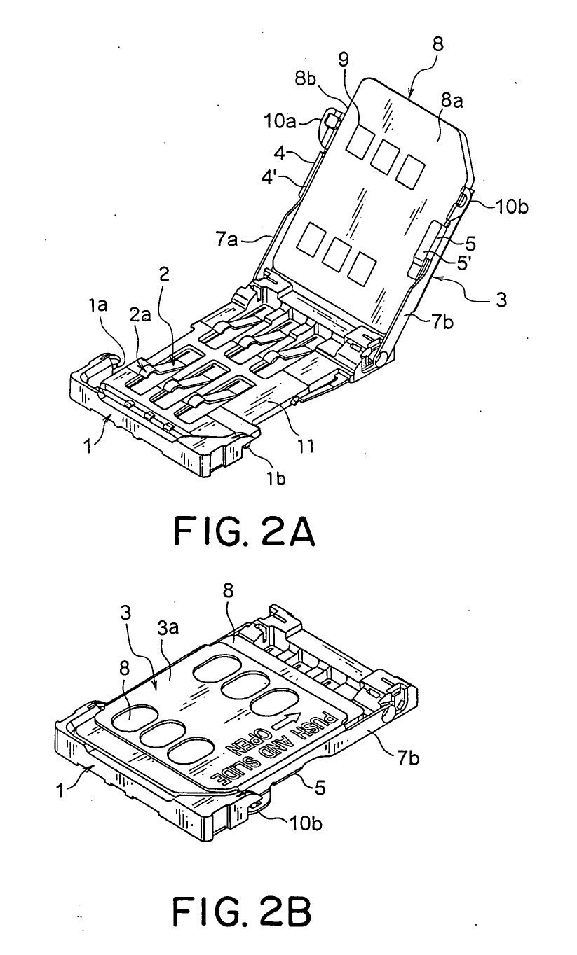

As shown in FIG. 2A, the card 8 has opposite side edges held by the first and the second holding portions 4 and 5, respectively. In this state, the cover 3 is closed as shown in FIG. 2B. Then, a plurality of pad portions 9 formed on a principal surface 8a of the card 8 are brought into press contact with the contacting portions 2a of the contacts 2, respectively. The pad portions 9 are eccentrically located near the first card holding portion 4, i.e., near one side surface 8b of the card 8.

The first card holding portion 4 has an end piece 4′ bent by an obtuse angle to be inclined outward with respect to a plane parallel to the card receiving portion 3a of the cover 3. On the other hand, the second card holding portion 5 has an end piece 5′ bent by a right angle to be in parallel to the card receiving portion 3a of the cover 3. As a countermeasure against noise, the cover 3 has locking portions 10a and 10b to be electrically connected to a ground line of a printed circuit board (not shown) on which the card connector is mounted. Each of the end pieces 4′ and 5′ may be called a guide piece or an engaging piece because it serves to guide the card 8 or to engage with the card 8.

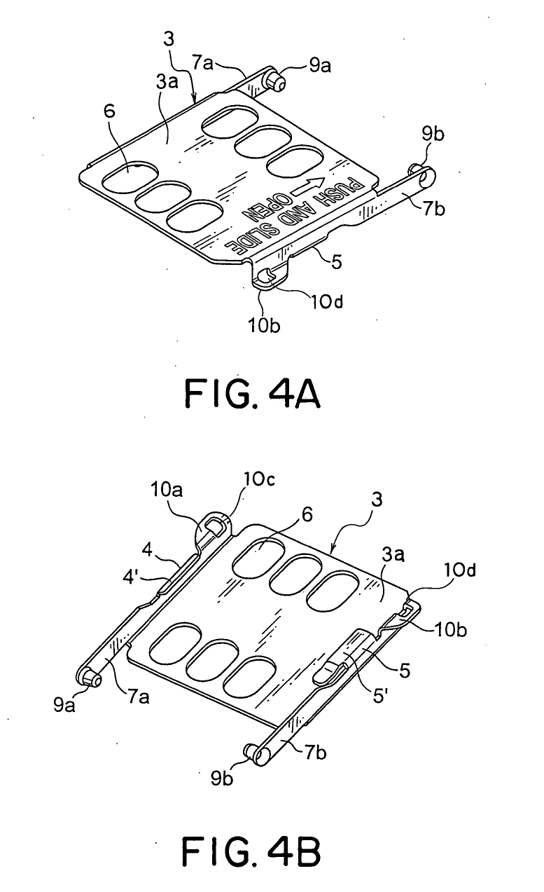

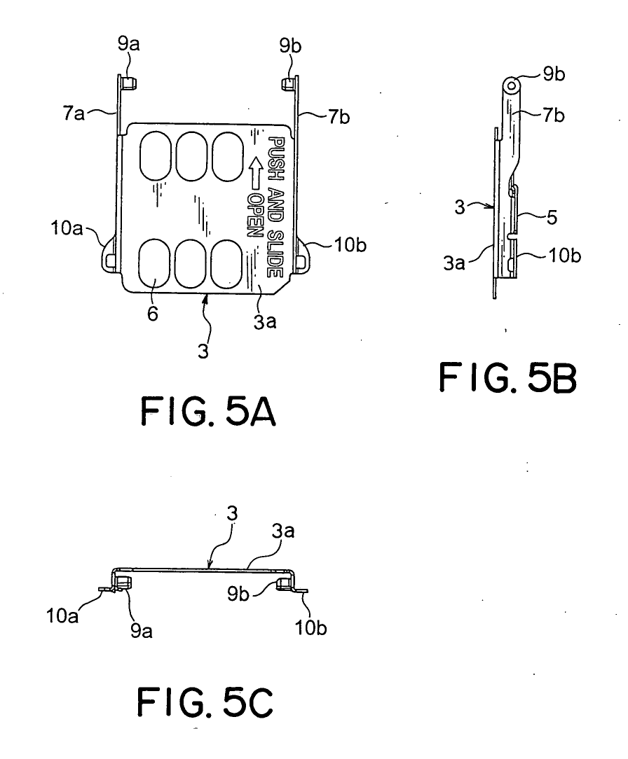

Referring to FIGS. 4A to 5C in addition, description proceeds.

The card receiving portion 3a of the cover 3 is provided with a plurality of (six in the illustrated example) elliptical escape holes 6 corresponding to the pad portions 9 of the card 8. The escape holes 6 prevents the contacting portions 2a of the contacts 2 from being pressed by the card receiving portion 3a of the cover 3 when the cover 3 is closed without holding the card 8. Therefore, the escape holes 6 of the card receiving portion 3a are formed at positions faced to the contacting portions 2a of the contacts 2 when the cover 3 is closed. In this manner, elastic restoring force of the contacts 2 is maintained. In order to make the contacts 2 face the escape holes 6, it is preferable that the contacts 2 are appropriately designed in shape and layout.

The cover 3 has a pair of arm portions 7a and 7b formed on its opposite sides and extending beyond one end of the card receiving portion 3a. The arm portions 7a and 7b are perpendicular to the card receiving portion 3a and are spaced from each other. The arm portions 7a and 7b are provided with shaft portions 9a and 9b formed integral therewith and protruding inward. The shaft portions 9a and 9b are rotatably fitted to recesses (not shown), which are formed at the first end portion of the insulator 1 so as to be recessed in the second direction A2.

The cover 3 further has locking portions 10a and 10b formed on its opposite sides near the other end of the card receiving portion 3a. Each of the locking portions 10a and 10b has a part which is formed by bending to extend outward in parallel to the card receiving portion 3a. The locking portions 10a and 10b have holes 10c and 10d, respectively. When the cover 3 is closed, conductive claw portions 1a and 1b formed near corner portions of the insulator 1 are inserted into the holes 10c and 10d and engaged with the locking portions 10a and 10b, respectively. As a consequence, the cover 3 is electrically connectable through the claw portions 1a and 1b to the printed circuit board on which the card connector is mounted.

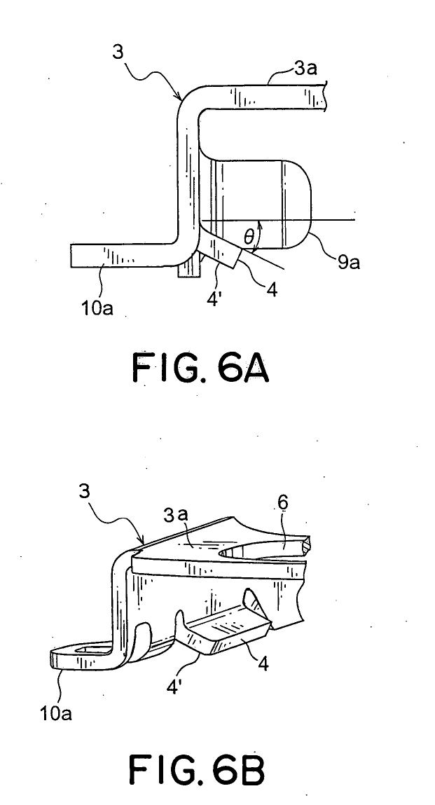

Referring to FIGS. 6A and 6B in addition, description will be made of inclination of the end piece 4′ of the first card holding portion 4.

An opening space inside the cover 3 for holding the card 8 is regarded as an opening portion. As illustrated in FIG. 6A, the end piece 4′ is inclined outward by an angle θ with respect to the plane parallel to the card receiving portion 3a of the cover 3 to thereby enlarge the opening portion. The end piece 4′ thus inclined supports a peripheral edge of the card 8.

In the above-mentioned card 8, a pattern of the pad portions 9 as a whole is disposed near the first card holding portion 4. However, the end piece 4′ of the first card holding portion 4 is inclined as mentioned above and is therefore prevented from contacting the pad portions 9 of the card 8. Therefore, the card 8 can be used without the risk of short-circuiting between a ground line and a signal line.

Further, the holes 10c and 10d of the locking portions 10a and 10b of the cover 3 are locked by the claw portions 1a and 1b of the insulator 1. Consequently, the pad portions 9 of the card 8 are stably kept contacted with the contacting portions 2a of the contacts 2. Therefore, the card connector is excellent in operability, durability, and reliability.

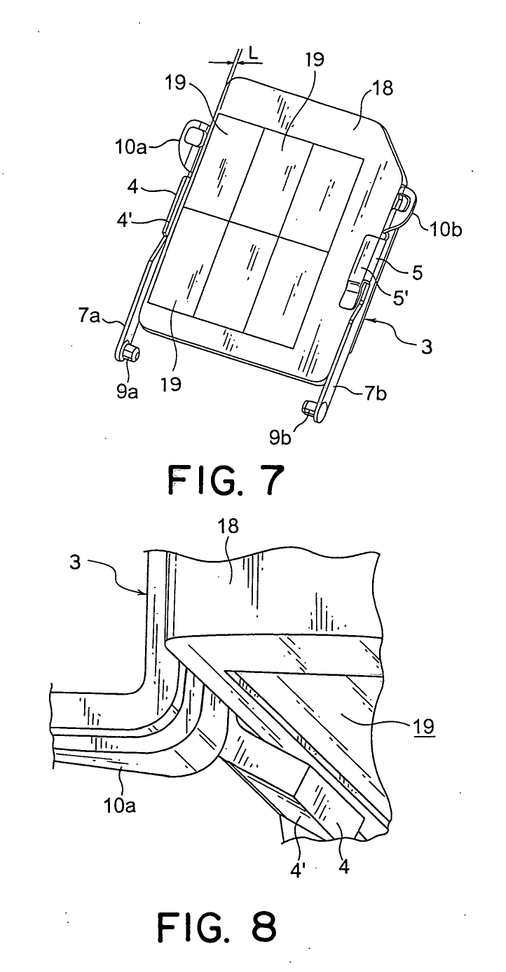

Referring to FIGS. 7 and 8, description will be made about a case where a different card 18 is used.

The card 18 is different from the above-mentioned card 8 in that a plurality of pad portions 19 have a different pattern. Specifically, the pad portions 19 of the card 18 are located nearer to the first card holding portion 4 than the pad portions 9 of the card 8 described above. Thus, the card 18 is a card called a mini UICC (mini universal IC card) in which a distance L between a side surface of the card 18 and the pad portions 19 is extremely short. In this case also, as is obvious from FIG. 8, the end piece 4′ of the first card holding portion 4 supports a peripheral edge of the card 18 without contacting the pad portions 19 of the card 18. Therefore, it is possible to use the card 18 without the risk of short-circuiting between the ground line and the signal line. In this case also, the card connector is excellent in operability, durability, and reliability like in the foregoing.

It is expected that a wide variety of cards having various kinds of patterns of the pad portions will be used with the card connector in the future. If the pattern of the pad portions of the card is arranged near the second card holding portion 5 contrary to the above, the end piece 5′ of the second card holding portion 5 is inclined outward by a predetermined angle θ. If the pattern of the pad portions of the card is arranged near both of the first and the second card holding portions 4 and 5, the end pieces 4′ and 5′ of the first and the second card holding portions 4 and 5 are inclined outward by a predetermined angle θ.

The cover 3 of any type may be formed by punching and bending using ordinary progressive press dies known in the art. It is desired that the position of each of the end pieces 4′ and 5′ of the first and the second card holding portions 4 and 5 of the card 3 is appropriately changed by bending or the like depending upon the pattern of the pad portions of the card or the thickness of the card.

While this invention has thus far been disclosed in conjunction with the preferred embodiment thereof, it will be readily possible for those skilled in the art to put this invention into practice in various other manners. For example, the card connector may be designed so that the insulator holds only a single contact or two contacts.

What is claimed is:

1. A card connector for connecting a card, the card connector comprising:
an insulator;
a conductive contact held by the insulator; and
a cover engaged with the insulator and movable with respect to the insulator for bringing the card into contact with the contact,
the cover having:
a card receiving portion for receiving the card; and
first and second card holding portions extending from the card receiving portion to hold opposite side edges of the card in cooperation with the card receiving portion,
at least one of the first and the second card receiving portions having an end piece extending in an inclined position with respect to the card receiving portion so that the end piece is contacted with one edge of the card but is faced to and spaced from a principal surface of the card which is adjacent to the one edge.

2. The card connector according to claim 1, wherein the cover is rotatable between an opened position at which the card receiving portion is spaced from one surface of the insulator and a closed position at which the card receiving portion is faced to the one surface.

3. The card connector according to claim 2, wherein the contact has a contacting portion protruding from the one surface of the insulator, the card receiving portion having a plate-like shape and provided with an escape hole faced to the contacting portion when the cover is at the closed position.

4. The card connector according to claim 2, wherein the insulator has a claw portion, the cover having a locking portion, the locking portion being engaged with the claw portion to maintain the closed position.

5. The card connector according to claim 2, wherein the cover is rotatable around a rotation axis extending in a predetermined direction, the first and the second card holding portions being spaced from each other in the predetermined direction, the contact being eccentrically located near the first holding portion, the first card holding portion having the end piece.

6. The card connector according to claim 5, wherein the second card holding portion has another end piece extending in parallel to the card receiving portion.

7. The card connector according to claim 1, wherein each of the first and the second card holding portions is formed by bending a part of the card receiving portion into a generally U-shaped section.

8. The card connector according to claim 1, wherein the cover has a pair of arm portions extending beyond the card receiving portion and spaced from each other, the arm portions having shaft portions protruding inward, respectively, the shaft portions being rotatably engaged with the insulator.

9. The card connector according to claim 1, wherein the cover is formed by punching and bending using a progressive press die.

10. The card connector according to claim 1, wherein the cover is made of a metal plate.
